(19) United States
(12) Patent Application Publication
(10) Pub. No.: US 2022/0272941 A1
(43) Pub. Date: Sep. 1, 2022

(54) GAME ANIMAL FEEDER CHUTE ASSEMBLY

(71) Applicant: Ray Hershberger, Middlefield, OH (US)

(72) Inventor: Ray Hershberger, Middlefield, OH (US)

(21) Appl. No.: 17/746,138

(22) Filed: May 17, 2022

Related U.S. Application Data
(63) Continuation-in-part of application No. 16/537,798, filed on Aug. 12, 2019, now Pat. No. 11,363,796.

(51) Int. Cl. A01K 5/02

(52) U.S. Cl. CPC A01K 5/0225

(57) ABSTRACT

A deer feeder chute assembly is provided. The device may include a baseplate that may be attached to an aftermarket barrel or other container for holding animal feed. A chute is disposed on one face of the baseplate, the chute having an input opening at one end and an output port disposed at an opposing end. The baseplate also includes a plurality of mounting apertures for receiving fasteners to attach the aftermarket barrel to the baseplate.

### I. BACKGROUND OF THE INVENTION

### A. Field of Invention

Embodiments of the invention may generally relate to domestic or wildlife feeders.

### B. Description of the Related Art

Gravity-driven game animal feeders are well known to hunters for baiting game animals such as deer. It is advantageous to have a feeder that can operate unattended for long periods of time so that animals become accustomed to receiving food from the device, without requiring frequent attention from the hunter. Generally, gravity-driven feeders operate by placing pelletized or granular animal feed into a hopper and allowing gravity to draw the feed through the device to an outlet. The larger the hopper, the longer the feeder can be left unattended. The feed may be eaten from the outlet or it may be expelled and eaten from the ground.

A wide variety of game animal feeders are available; however, all have certain shortcomings. One problem is that known gravity-driven feeders tend to be very bulky because the feed hopper tends to be large. However, bulk tends to increase shipping costs and therefore tends to increase the retail price. Many of the feeders are one large piece, which makes them very inefficient for shipping purposes due to cargo space requirements. One attempt at reducing cost is to fabricate feeders from light materials like plastics. However, the costs savings from reduced weight can be lost by the increased costs of molding and finishing plastic goods. Metals may add less fabrication costs, but their weight tends to add to shipping costs thereby diminishing if not eliminating the costs savings. Another solution is to add electronic parts to meter out feed over time at scheduled intervals. This tends to require a smaller hopper because the feed delivery rate is better controlled. However, adding electronics and moving parts increases costs in materials, fabrication, and assembly. Moreover, increasing the complexity of the device tends to increase opportunities for failure. What is missing from the art is a modular feed chute assembly that can be readily installed by the end-user on an arbitrary aftermarket container.

Some embodiments of the present invention may provide one or more benefits or advantages over the prior art.

### II. Summary of the Invention

Embodiments of the invention are directed to gravity driven game animal feeders that allow a feeder to operate unattended for long periods of time. The assembly includes a baseplate having a first face and a second face opposing the first face. A chute is disposed on the first face of the baseplate, the chute having an input opening at one end. An output port is disposed at an end of the chute opposing the input opening. The output port is in fluid communication with the input opening and is communicable with the interior of an aftermarket barrel supplied by the user. A plurality of mounting apertures are disposed in the baseplate. Embodiments may also include a dam at the chute's output port opening and may include, alternatively or in addition to the dam, a baffle for resisting feed flow. The baffle may be hingedly connected to a top wall of the chute to allow for adjusting resistance to feed flow.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1 is a semi-exploded sideview with certain portions transparent to show internal structures;

FIG. 2 is a bottom view of the baseplate of the embodiment illustrated in FIG. 1;

FIG. 3 is a top view of the baseplate illustrated in FIG. 2;

FIG. 4 is a plan view of a feed chute of the embodiment illustrated in FIG. 1 looking into the opening defined by the flange;

FIG. 5 is a view of the feed chute shown in FIG. 4 looking into the feed output port;

FIG. 6 is a side perspective view of an embodiment;

FIG. 7 is a top view of the embodiment of FIG. 6;

FIG. 8 is a bottom view of the embodiment of FIG. 6;

FIG. 9 is a view into a chute of the embodiment of FIG. 6; and

FIG. 10 is a transparent partial view of the embodiment of FIG. 6 taken from box 10 of FIG. 6.

### IV. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Terms of degree, terms of approximation, and/or subjective terms may be used herein to describe certain features or elements of the invention. In each case sufficient disclosure is provided to inform the person having ordinary skill in the art in accordance with the written description requirement and the definiteness requirement of 35 U.S.C. 112.

Terms indicating orientation including top, bottom, side and so on, are not intended to limit the invention to particular orientations. Rather, such terms are used to as a matter of convenience consistent with orientations shown in the appended drawings.

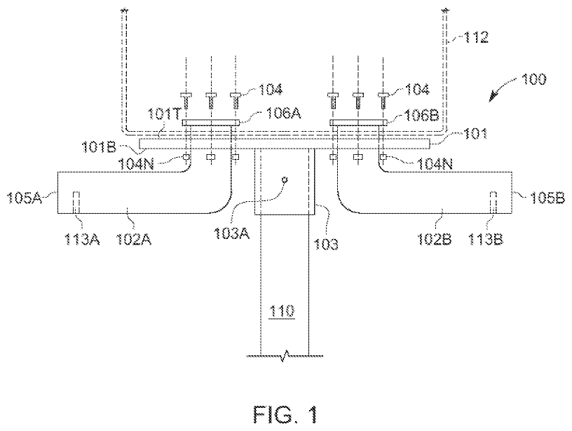

Referring now to the drawings wherein the showings are for purposes of illustrating embodiments of the invention only and not for purposes of limiting the same, FIG. 1 is a side view of a gravity-driven animal feeder chute assembly 100 according to one example embodiment of the invention. The embodiment includes a baseplate 101 with holes (not shown) formed therein to receive feed chutes. A pair of elbow-shaped feed chutes 102A, 102B are shown with flanges 106A, 106B at one end, and output ports 105A, 105B at the other end. The chutes 102A, 102B include optional dams 113A, 113B near the openings 105A, 105B. The dams 113A, 113B are located inside the chutes 102A, 102B, and serve to retain feed in the chute. In embodiments that include dams, the person having ordinarily skill will be able to readily size and locate the dams so that feed does not freely flow from the container while still allowing the game animal to feed directly from the openings 105A, 105B.

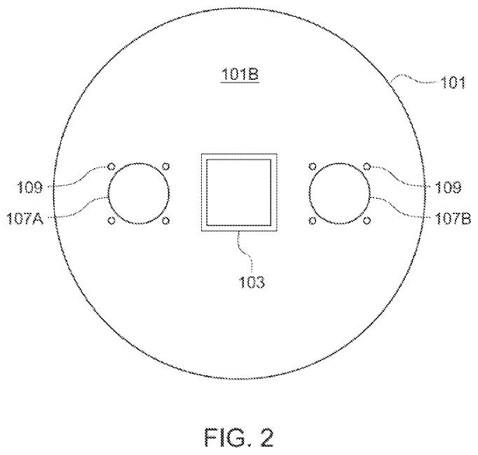

The chutes 102A, 102B are attached to the base plate 101 with fasteners, which in this embodiment are bolts 104 and nuts 104N; however, the person having ordinary skill will readily understand that a variety of fasteners are equally suitable including, without limitation, screws and rivets. A container 112 is interposed between the flanges 106A, 106B and a top face 101T of the baseplate 101, thereby mounting the embodiment 100 to the container 112. A stand bracket 103 is centrally located on the baseplate 101. In practice, a user of the illustrated embodiment would provide a feed container 112 with holes cut in the bottom, the holes being sized to receive the chutes 102A, 102B. Moreover, the container would include mounting apertures surrounding the holes, which cooperate with mounting apertures 109 (FIG. 2) of the flanges 106A, 106B and baseplate 101 to receive fasteners 104.

With continuing reference to FIG. 1, the bracket 103 is structured to receive a post 110 suitable for vertically supporting the assembly 100. For example, and without limitation, a suitable post may be fabricated by the user from 4×4 treated lumber. One or more walls of the bracket 103 may include an opening 103A which may receive a fastener (not shown), such as a nail or wood screw, for attaching the bracket 103 to the post 110. The person having ordinary skill in the art will be able to readily select a fastener appropriate to a given embodiment; however, in the embodiment described here, a wood screw would be an appropriate choice provided the post 110 is wooden.

FIG. 2 is a bottom view of the baseplate 101 alone without chutes installed. The bottom face 101B of the baseplate 101 is shown. The bottom face 101B is also referred to herein as the first face. Moreover, structures disposed on first face 101B are said to be disposed on the first face side of the embodiment 100. The stand bracket 103 of this embodiment is a four-walled structure extending away from the bottom face 101B of the baseplate 101. The bracket 103 cooperates with a stand 110 such as, without limitation, a length of 4×4 treated lumber (see FIG. 1). One or more walls of the bracket may include an opening 103A (See FIG. 1) for receiving a fastener such as a wood screw or bolt to fasten the bracket 103 to the stand.

With continuing reference to FIG. 2, chute openings 107A, 107B are formed in the baseplate 101, and define through-holes extending from the bottom face 101B to the top face 101T. The chute openings 107A, 107B are sized to receive corresponding chutes 102A, 102B. The fit between the chute openings 107A, 107B and the chutes 102A, 102B is not critical, but a clearance fit, including but not limited to a loose running fit, may be advantageous for fabrication and assembly purposes. The chute openings 107A, 107B are proximal to mounting apertures 109 located about the perimeter of the chute openings 107A, 107B. The mounting apertures 109 cooperate with similar mounting apertures located on the flanges 106A, 106B and on the feed container 112 (see FIG. 1) to attach the chutes 102A, 102B and the feed container 112 to the baseplate 101.

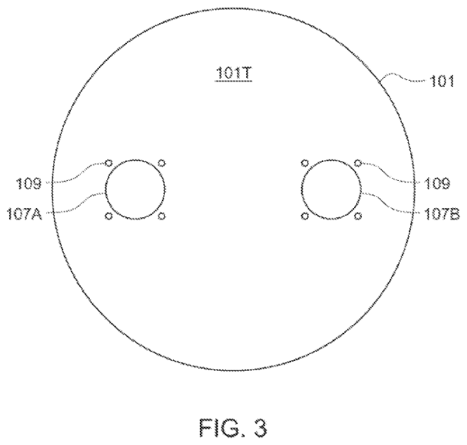

FIG. 3 is a view of the reverse side of the baseplate 101, namely the top face 101T which is also referred to herein as the second face. Moreover, structures disposed on second face 101T are said to be disposed on the second face side of the embodiment 100. FIG. 3 illustrates that the chute openings 107A, 107B and the mounting apertures 109 all define through-holes extending from the bottom face 101B to the top face 101T.

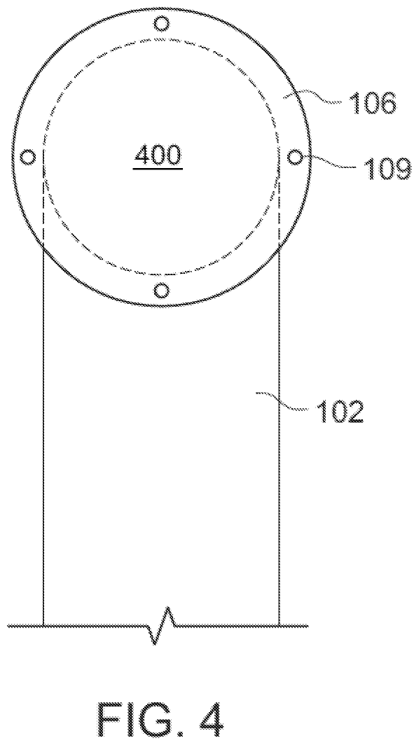

FIG. 4 is a view of a feed chute 102, which corresponds to both 102A and 102B. The view is directed perpendicular to the flange 106 and looking into an input opening 400 of the chute 102 defined by the flange 106. Mounting apertures 109 are shown about the perimeter of the flange 106. Similar to the mounting apertures 109 of the baseplate 101, the mounting apertures 109 of the flange 106 are sized to receive fasteners such as bolts 104 (see FIG. 1). Accordingly, the flange 106 is adapted to cooperate with the baseplate 101 in a fastened relation.

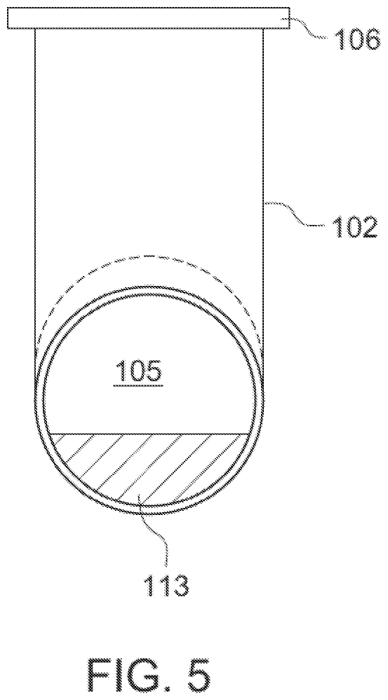

FIG. 5 is a view of the feed chute 102 looking into the feed output port 105. A semi-circular dam 113 is shown inside chute 102 near the output port 105. Although the dam 113 is shown as a solid wall, the invention is not limited in this way. Alternative dam structures can include, without limitation, a porous screen sized to allow feed to pass through the screen. Accordingly, the screen serves to provide resistance to flow of the feed while still permitting feed to pass through the screen as the embodiment is jarred, for instance, by an animal attempting to feed. Other dams 113 within the scope of the invention can include a forward-sloping wall which may provide resistance to flow of feed while still allowing the feed to flow as the embodiment is jarred by a feeding animal.

While the chutes 102A, 102B shown in FIGS. 1, 4 and 5 are all 90 degree elbows, the invention is not limited in this way. The invention is intended to include any suitable chute geometry for conveying feed from a container to a game animal. Such geometries can include, without limitation, an output port 105 angled slightly upward to retain feed, which may be used in conjunction with, or instead of, a dam 113. Alternatively, the output port 105 may be angled slightly downward to assist the flow of feed and, again, may be used with or without a dam 113. Such geometries may be advantageously used in conjunction with a dam 113 structure as described elsewhere herein, which may prevent the container from immediately emptying, or emptying more easily or quickly than desired.

The feed chute assembly 100 is co-operable with a wide variety of containers for holding animal feed. For instance, and without limitation, such containers can include plastic barrels, plastic trashcans, steel trashcans, 55 gallon steel drums, and so on. The specific nature of the container is not important, but it should include a suitably flat bottom surface to which may be attached the feed chute assembly 100. Advantageously, the container may include a closed top and sides to shield the animal feed from rain and snow, for instance. The user of the feed chute assembly 100 may cut out holes in the bottom wall of the container to communicate the contents of the container to the feed chutes 102A, 102B of the assembly 100, and may further drill mounting apertures around the holes to cooperate with complementary mounting apertures 109 of the flanges 106A, 106B and the baseplate 101.

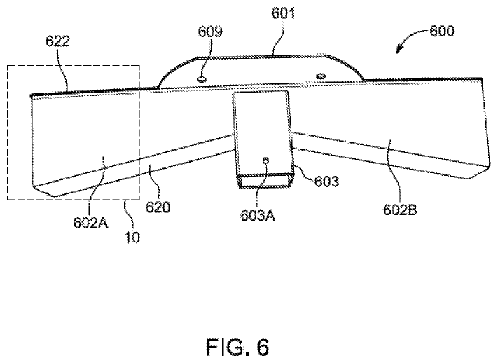

FIG. 6 shows an embodiment 600 having sloped chutes 602A, 602B. A baseplate 601 of the embodiment 600 includes a plurality of mounting apertures 609 for fastening an aftermarket container 112 (see FIG. 1) to the baseplate 601. In some embodiments the chutes 602A, 602B may be attached to the baseplate 601 in the manner described above concerning chutes 102A, 102B and baseplate 101, namely, through the use of fasteners cooperating with the baseplate 601 and flanges (not shown) of the respective chutes 602A, 602B. In other embodiments the chutes 602A, 602B may be welded to the baseplate 601 and/or the stand bracket 603. Similar to stand bracket 103 (FIG. 1), stand bracket 603 includes an opening 603A sized to receive a fastener such as a screw, nail, or bolt to secure the embodiment 600 to a post 110 (see FIG. 1). In still other embodiments the baseplate may be unitary with a top wall of the chute or chutes, as shown in FIG. 6.

With continuing reference to FIG. 6, the chutes 602A, 602B comprise a more or less horizontal top wall 622 and a downward sloping bottom wall 620. As used here, the terms top and bottom are intended to indicate the relative positon of walls 620 and 622 when the embodiment 600 is operationally installed. The specific angle of the downward slope is not critical. The person having ordinary skill in the art will be readily capable of selecting a slope that provides a desirable feed emptying rate. Operable slope angles range from 15° to 75°+/−10%.

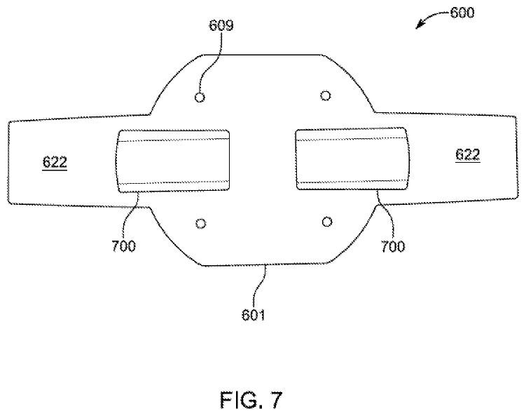

Turning to FIG. 7, the embodiment 600 is shown from above. A pair of input openings 700 are visible. The illustrated input openings 700 are generally rectangular in shape; however, the person having ordinary skill will understand that the shape of the input openings is not critical. When a hopper (e.g. 112 of FIG. 1) is installed on the embodiment 600 the input openings 700 communicate with one or more complementary openings in the hopper to receive feed from the hopper.

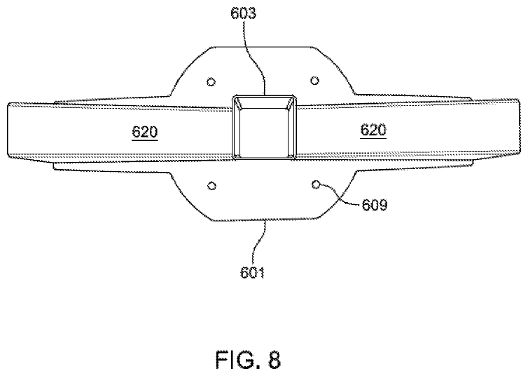

FIG. 8 is a bottom view of embodiment 600 showing the stand bracket 603 relative to the downward-sloped bottom walls 620 and the base plate 601.

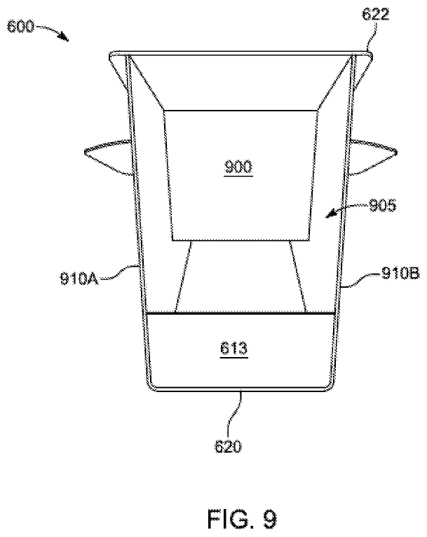

FIG. 9 is a view into an output port 905 of embodiment 600. The top wall 622, bottom wall 620 and sidewalls 910A, 910B. A dam 613 closes a lower section of the output port 905. A baffle 900 is shown inside the output port 905 extending downward from the top wall 622. The baffle 900 and dam 613 cooperate to impede the flow of feed through the output port 905 so that the downward sloping bottom wall 620 does not cause rapid emptying of the hopper.

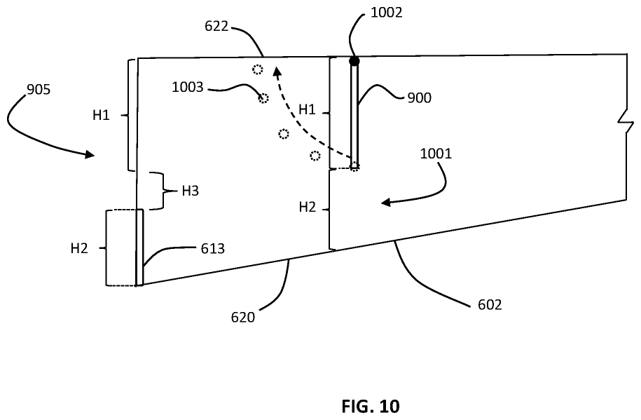

FIG. 10 shows the relative sizes and placement of the dam 613 and baffle 900. This is a transparent side view of the portion of embodiment 600 enclosed in box 10 in FIG. 6. While the relative proportions of the dam 613 and baffle 900 are not critical, FIG. 10 illustrates a baffle 900 having a height H1, leaving a lower gap 1001 having a height H2. The dam 613 also has a height H2. Since the lower wall 620 slopes away from the top wall 622, rather than running parallel to it, the total height at the opening 905 of the chute 602 is the sum of H1, H2 and a third height H3. The tendency for feed to flow through the chute 602 under the influence of gravity can be tuned by adjusting the downward sloping angle of the lower wall 620, the height of the dam 613 and the height of the baffle 900. Furthermore, the heights of the baffle 900 and damn 613 can vary independent of each other. In other words, providing a baffle 900 with a greater or lesser height H1 does not require the dam 613 to change by a corresponding amount.

In some embodiments, the dam 613 can extend about 25% of the distance from the bottom wall 620 to the top wall 622, or anywhere between 10% and 50% of the distance from the bottom wall 620 to the top wall 622. The baffle 900 can extend about 75% of the distance from the top wall 622 to the bottom wall 620, or anywhere between 10% and 90% of the distance from the top wall 622 to the bottom wall 620. The person having ordinary skill can select a dam size and a baffle size as a matter of design choice without undue experimentation. Feeds with a larger resistance to flow will benefit from a smaller dam 613 and/or baffle 900, while feeds with a smaller resistance to flow will benefit from a larger dam 613 and/or baffle 900.

Optionally, embodiments may provide for further control over feed flow by adding a hinge 1002 between the top wall 622 and the baffle 900, thereby allowing the baffle 900 to open or close in the manner of a flapper valve. The baffle may be fixed in selected positions according to any of a variety of well-known means, one of which is illustrated in FIG. 10. More specifically, apertures 1003 are provided in the sidewall of the chute 602, which can receive indexing pins that fix the position of the baffle 900.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I claim:

1. A gravity-driven feed chute assembly, comprising:
a baseplate having a first face and a second face opposing the first face;
a chute disposed on the first face of the baseplate, the chute having an input opening at one end;
an output port disposed at an end of the chute opposing the input opening, wherein the output port is in fluid communication with the input opening; and
a plurality of mounting apertures disposed in the baseplate.

2. The gravity-driven feed chute assembly of claim 1 further comprising a first chute opening in the baseplate extending between the first face and the second face;

3. The gravity-driven feed chute assembly of claim 1 further comprising a plurality of fasteners co-operable with the plurality of mounting apertures.

4. The gravity-driven feed chute assembly of claim 3, wherein a wall of a feed container is co-operable with the plurality of mounting apertures and the plurality of fasteners to fasten the feed container to the second face of the baseplate, and wherein the chute is in fluid communication with an interior of the feed container through one or more openings in the wall of the feed container.

5. The gravity-driven feed chute assembly of claim 1, further comprising a stand bracket disposed on the first face of the baseplate, wherein the stand bracket is co-operable with a stand to vertically support the baseplate.

6. The gravity-driven feed chute assembly of claim 1 further comprising a dam extending upward from a bottom wall off the chute, the dam being proximal to the output port of the chute.

7. The gravity-driven feed chute assembly of claim 6, wherein the bottom wall of the chute is obliquely angled relative to a top wall of the chute.

8. The gravity-driven feed chute assembly of claim 7, wherein the oblique angle is from 15° to 75°+/−10%.

9. The gravity-driven feed chute assembly of claim 1 further comprising a baffle extending downward from a top wall of the chute, the baffle being disposed between the input opening of the chute and the output port of the chute.

10. The gravity-driven feed chute assembly of claim 9 further comprising a hinge linking one end of the baffle to the top wall of the chute.
